(19) United States
(12) Patent Application Publication
(10) Pub. No.: US 2004/0039950 A1
(43) Pub. Date: Feb. 26, 2004

(54) Electronic apparatus having two systems each with CPU

(75) Inventors: Naohiko Okamoto, Ome-shi (JP); Yuichi Tomiyasu, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/615,195

(22) Filed: Jul. 9, 2003

(30) Foreign Application Priority Data
Aug. 23, 2002 (JP) 2002-243827

(51) Int. Cl. G06F 1/26

(52) U.S. Cl. 713/300

(57) ABSTRACT

When a power button is pressed, an embedded controller (EC) first starts an operating system which is function limited but short in starting time on a first system having a CPU. After that, upon receiving a request to use multifunctional software, the EC starts an operating system which is multifunctional but long in starting time on a second system having a CPU, thus switching between the operating systems to allow selective use thereof.

### CROSS-REFERENCE TO RELATED APPLICATIONS

This application is based upon and claims the benefit of priority from the prior Japanese Patent Application No. 2002-243827, filed Aug. 23, 2002, the entire contents of which are incorporated herein by reference.

### BACKGROUND OF THE INVENTION

1. Field of the Invention

The present invention relates to electronic apparatus such as a personal computer.

2. Description of the Related Art

In recent years, electronic apparatus, such as notebook computers, has come into wide use, which, when connected to an AC adapter, is powered from an external power supply and, otherwise, is powered from a battery. This type of electronic apparatus can run not only basic software, such as word-processing software and spreadsheet software but also Internet-related software, such as mailer software and browser software. Moreover, depending on the user, various pieces of software including business presentation creation software are run.

These pieces of software are all run under the control of an operating system (OS). Operating systems include ones which are supposed to be employed mainly indoors, for example, in offices and homes, that is, which are supposed to operate from external power supplies and ones which are supposed to be employed mainly outdoors, for example, during users' absence from their offices or homes or when on the move, that is, which are supposed to operate from batteries. In general, the former are multifunctional with the main purpose of supporting a large variety of functions of various pieces of software, and the latter have functions limited to main ones with the main purpose of reducing the weight and power consumption of apparatus.

It is therefore desirable for the user to choose an operating system to be used in his or her own electronic apparatus in view of his or her mode of use of the apparatus.

The former operating systems have an advantage of being multifunctional and a disadvantage of requiring a long starting time. On the other hand, the latter operating systems have an advantage that they can be activated in a short time and a disadvantage of being limited in function. Namely, it can be said that a tradeoff relationship exists between the former operating systems and the latter operating systems.

Many users use their own electronic apparatus indoors in some cases or outdoors in some cases. It will therefore be required to allow users to use the former operating systems or the latter operating systems to suit time and place.

However, the conventional way of using the operating systems to suit time and place is not very convenient; that is, it is required to make a choice from two operating system at activation time or it is required to first stop one operating system and then activate the other operating system anew. This is because one CPU selectively activates either one of the two operating systems.

It is natural that there is a large difference between system configurations adapted to run the former operating systems and system configurations adapted to run the latter operating systems. To begin with, it is not proper to run an operating system on a system configuration adapted to run the other operating system.

As an example, Jpn. Pat. Appln. KOKAI Publication No. 2001-125672, discloses a computer having two CPUs to run two operating systems individually. With this computer system, two motherboards are mounted on a frame and a different operating system is installed into each of the motherboards. The operating systems are run at the same time. However, this computer is intended to reduce the area taken up by it on the floor and substantially it is nothing but two computer systems that are housed in a single case.

### BRIEF SUMMARY OF THE INVENTION

According to an aspect of the invention provides an electronic apparatus comprising: a first system having a first CPU; a second system having a second CPU; a connection unit configured to connect the first system and the second system; and a power application control unit configured to control the application of power to the first system and the second system through the connection unit.

According to another aspect of the invention provides an electronic apparatus comprising: a first system having a first CPU; a second system having a second CPU; a connection unit configured to connect the first system and the second system; and a system switching unit configured to switch between the first system and the second system for selective use thereof through the connection unit.

According to another aspect of the invention provides an electronic apparatus comprising: a first system having a first CPU; a second system having a second CPU; a connection unit configured to connect the first system and the second system; and a file management unit configured to manage a file retained by the first system and a file retained by the second system through the connection unit.

An advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram of electronic apparatus according to a first embodiment of the present invention;

FIG. 2 is a flowchart illustrating power application control and system switching control in the electronic apparatus of the first embodiment;

FIG. 3 is a flowchart illustrating power application control and system switching control in electronic apparatus according to a second embodiment of the present invention;

FIG. 4 is a flowchart illustrating power application control and system switching control in electronic apparatus according to a third embodiment of the present invention;

FIG. 5 is a flowchart illustrating power application control and system switching control in electronic apparatus according to a fourth embodiment of the present invention;

FIG. 6 is a flowchart illustrating power application control and system switching control in electronic apparatus according to a fifth embodiment of the present invention;

FIG. 7 is a flowchart illustrating power application control and system switching control in electronic apparatus according to a sixth embodiment of the present invention;

FIG. 8 is a block diagram of electronic apparatus according to a seventh embodiment of the present invention;

FIG. 9 is a flowchart illustrating power application control and system switching control in electronic apparatus of the seventh embodiment;

FIG. 10 is a block diagram of electronic apparatus according to an eighth embodiment of the present invention;

FIG. 11 shows an arrangement of the selector in electronic apparatus according to a ninth embodiment of the present invention; and

FIG. 12 shows an arrangement associated with a card slot provided in the shared section of electronic apparatus according to a tenth embodiment of the present invention.

### DETAILED DESCRIPTION OF THE INVENTION

The embodiments of the present invention will be described below with reference to the drawings.

[First Embodiment]

A first embodiment of the present invention will be described.

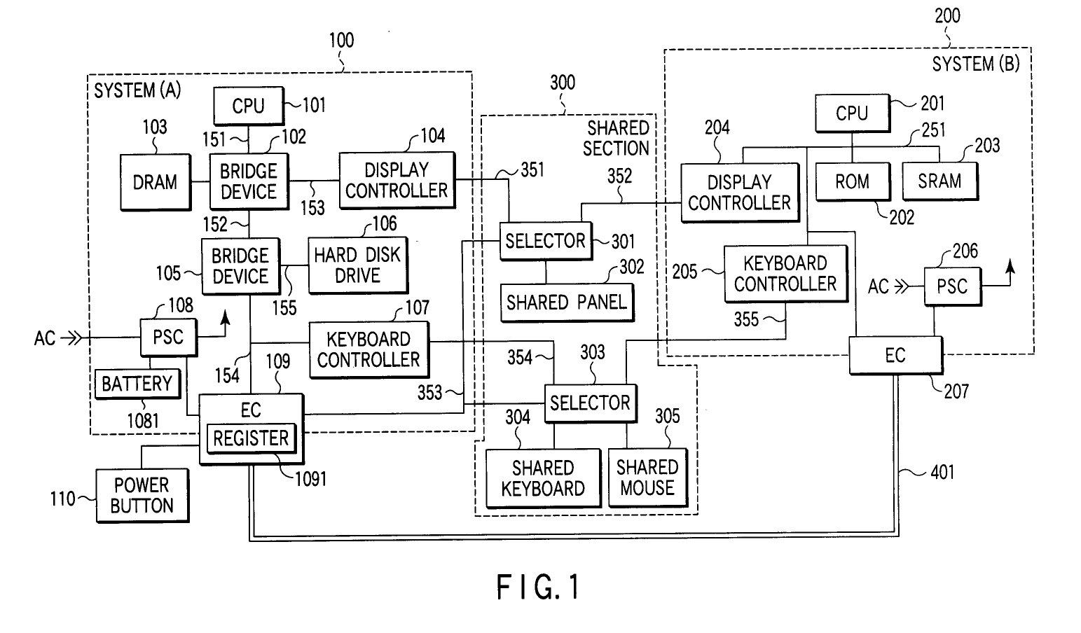

FIG. 1 is a block diagram of a piece of electronic apparatus according to the first embodiment of the present invention.

This electronic apparatus, which is, for example, a notebook personal computer, comprises a system (A) 100 having a CPU 101 and a system (B) 200 having a CPU 201. The electronic apparatus is provided with a section 300 shared by the system (A) 100 and the system (B) 200.

In this electronic apparatus, on the side of the system (A) 100, an operating system, such as Windows 2000(R) developed by Microsoft Corp., which is multifunctional but long in starting time is run. On the side of the system (B) 200, on the other hand, an operating system, such as Windows CE(R) developed by Microsoft Corp., which is function limited but short in starting time is run. The apparatus is intended to allow system convenience to be enhanced by comprising two CPUs (CPU 101 and CPU 201) for starting the two individual operating systems and performing control operations to make the demerit of one operating system and the merit of the other operating system complementary to each other. This will be described in detail below.

The system (A) 100 includes, in addition to the CPU 101, a bridge device 102, a DRAM 103, a display controller 104, a bridge device 105, a hard disk drive 106, a keyboard controller 107, a power supply controller (PSC) 108 for the system A, and an embedded controller (EC) 109.

The bridge device 102 is adapted to connect a CPU bus 151 and a PCI bus 152 together and controls access to the DRAM 103. The bridge device 102 is connected to the display controller 104 by an AGP port 153.

The DRAM 103, which is a memory unit that serves as main storage of the system (A) 100, stores various programs describing the procedures of the CPU 101 and data input to and output from these programs.

The display controller 104, which is a device that provides output function of the user interface in the system (A) 100, outputs display data produced by the CPU 101 to a shared panel 302 to be described later.

The bridge device 105 is adapted to connect the PCI bus 152 and an ISA bus 154 together. To the bridge device 105 the hard disk drive 106 is connected by an IDE interface 155.

The hard disk drive 106, which is a memory unit that serves as the external storage of the system (A) 100, stores programs and data in large quantities as the secondary storage of the DRAM 103.

The keyboard controller 107, which is a device that provides input function of the user interface in the system (A) 100, transfers to the CPU 101 the contents of operations of a shared keyboard 304 and a shared mouse 305, which will be described later.

The PSC 108 provides power required to operate each component comprising the system (A) 100. When connected to an AC adapter, the PSC 108 provides power from an external power supply to each component. When not connected to the AC adapter, the PSC 108 provides power from a battery 1081 to each component. The battery 1081 is a secondary battery that can be charged repeatedly. When connected to the AC adapter, the PSC 108 charges the battery 1081. The PSC 108 also provides power to each component in the shared section 300. The PSC 108 is controlled by the EC 109. Suppose that the embedded controller 109 is supplied with power all the time.

The EC 109 performs, in addition to drive control of the PSC 108, power application control in the entire apparatus, system switching control and control over the shared section 300 while communicating with an embedded controller (EC) 207 to be described later in the system (B) 200. To the EC 109 is connected a power button 110 that allows the user to turn on or off power to the electronic apparatus.

The system (B) 200 is provided, in addition to the CPU 201, with a ROM 202, an SRAM 203, a display controller 204, a keyboard controller 205, a power supply controller (PSC) 206 for the system (B), and the EC 207 which are interconnected by an SRAM bus 251 that the CPU 201 provides.

As described previously, it is assumed that a function limited operating system is operated on the system (B) 200. Therefore, a CPU that is somewhat inferior to the CPU 101 in the system (A) 100 will be commonly adopted as the CPU 201. Of course, a CPU which is identical or superior in performance to the CPU 101 may be used.

The ROM 202 is a memory unit that stores programs describing the procedures of the CPU 201 and various setting information. The SRAM 203 is a memory unit which serves as a work area of the CPU 201.

The display controller 204, which is a device that provides output to the user interface in the system (B) 200, outputs display data produced by the CPU 201 to the shared panel 302 to be described later. The keyboard controller 205, which is a device that provides input to the user interface in the system (A) 100, transfers the contents of operations of the shared keyboard 304 and the shared mouse 305 to the CPU 201.

The PSC 206 provides power required to operate each component comprising the system (B) 200. When connected to an AC adapter, the PSC 206 provides power from an external power supply to each component. When not connected to the AC adapter, the PSC 206 provides power from the battery 1081 to each component. The PSC 206 is controlled by the EC 207. Suppose that the EC 207 is supplied with power all the time.

The EC 207 performs, in addition to drive control of the PSC 206, power application control in the entire apparatus, system switching control, and control over the shared section 300 while communicating with the EC 109 in the system (A) 100.

The shared section 300 has a selector 301, the shared panel 302, a selector 303, the shared keyboard 304, and the shared mouse 305.

The selector 301 is connected with the display controller 104 in the system (A) 100 through an interface signal line 351, with the display controller 204 in the system (B) 200 through an interface signal line 352, and with the EC 109 in the system (A) 100 through a select signal line 353. In response to a select signal output from the EC 109 in the system (A) 100, the selector 301 supplies the shared panel 302 with either display data output from the display controller 104 in the system (A) 100 or display data output from the display controller 204 in the system (B) 200.

The selector 303 is connected with the keyboard controller 107 in the system (A) 100 through an interface signal line 355, with the keyboard controller 205 in the system (B) 200 through an interface signal line 356, and with the EC 109 in the system (A) 100 through the select signal line 353. In response to a select signal output from the EC 100 in the system (A) 100, the selector 303 applies operation signals from the shared keyboard 304 and the shared mouse 305 to either the keyboard controller 107 in the system (A) 100 or the keyboard controller 205 in the system (B) 200.

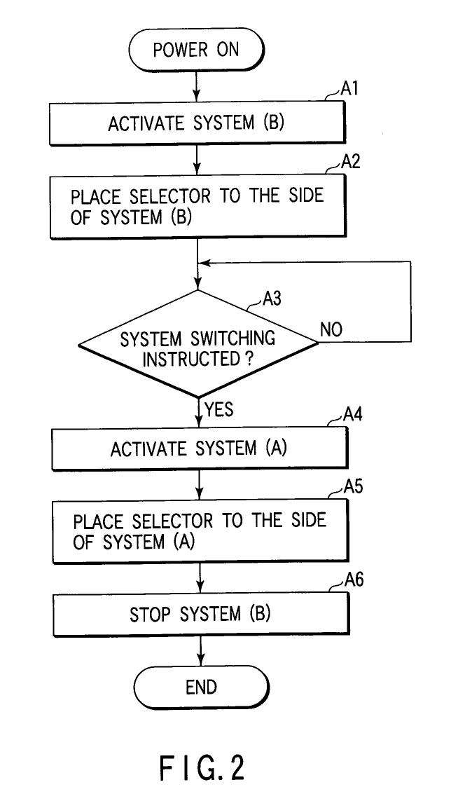

Reference is now made to FIG. 2 to describe the power application control and the system switching control in the electronic apparatus in the first embodiment which are carried out cooperatively by the EC 109 in the system (A) 100 and the EC 207 in the system (B) 200.

When the power button 110 is pressed, the EC 109 instructs the EC 207 to apply the power to the system (B) 200 (step A1). Thereby, the operating system that is function limited but short in starting time is activated. At this point, the EC 109 sets the selectors 301 and 303 to select the system (B) 200 (step A2).

The EC 207, after having activated the operating system, monitors whether an instruction to switch between the systems has been given (step A3). The notification of occurrence of the system switching instruction to the EC 207 may be made by preparing a dedicated utility program and clicking an icon presented by it with the shared mouse 305. Alternatively, the EC 207 may be notified to that effect by unifying icons presented by both the operating systems and, when clicking an icon of multifunctional software (instruction to run multifunctional software) that is not supported by the operating system in the system (B) 200, causing a utility program to recognize that instruction and notify the EC 207 of it. Furthermore, pressing two or more given keys simultaneously on the shared keyboard 304 may be interpreted as a system switching instruction with notification to the EC 207.

When the system switching instruction is given (YES in step A3), the EC 207 notifies the EC 109 to that effect. Then, the EC 109 starts application of the power to the system (A) 100 (step A4). As a result, the operating system that is multifunctional but long in starting time is started. The EC 109 then switches the selectors 301 and 303 to the side of the system (A) 100 (step AS) and instructs the EC 207 to stop application of the power to the system (B) 200 (step A6). The instructed EC 207 presents a shutdown signal to the operating system.

Thus, in the electronic apparatus of the first embodiment, an operating system that supports only basic software, such as a mailer and browser, and is short in starting time is first started, and an operating system which is multifunctional but long in starting time is started when sophisticated software is used. This allows the convenience of users who make much use of the basic software but little use the sophisticated software to be increased.

In addition, the provision of a CPU for each system allows the time required to switch between the systems to be reduced in comparison with the case where one of the systems is stopped first and the other is then started.

The first embodiment has been described by way of switching from the second system (B) 200 on which an operating system that is function limited but short in starting time is run to the first system (A) 100 on which an operating system that is multifunctional but long in starting time is run. However, the configuration of this embodiment naturally allows switching from the first system (A) 100 to the second system (B) 200 after switching from the second system (B) 200 to the second system (A) 100.

[Second Embodiment]

A second embodiment of the present invention will be described next.

In the electronic apparatus of the second embodiment, the EC 109 has a function of setting whether to apply the power to the system (A) 100 in advance when the power button 110 is pressed. To this end, the EC 109 has a built-in register 1091 which holds the setting. The register 1091 is updated, for example, by executing a dedicated utility program.

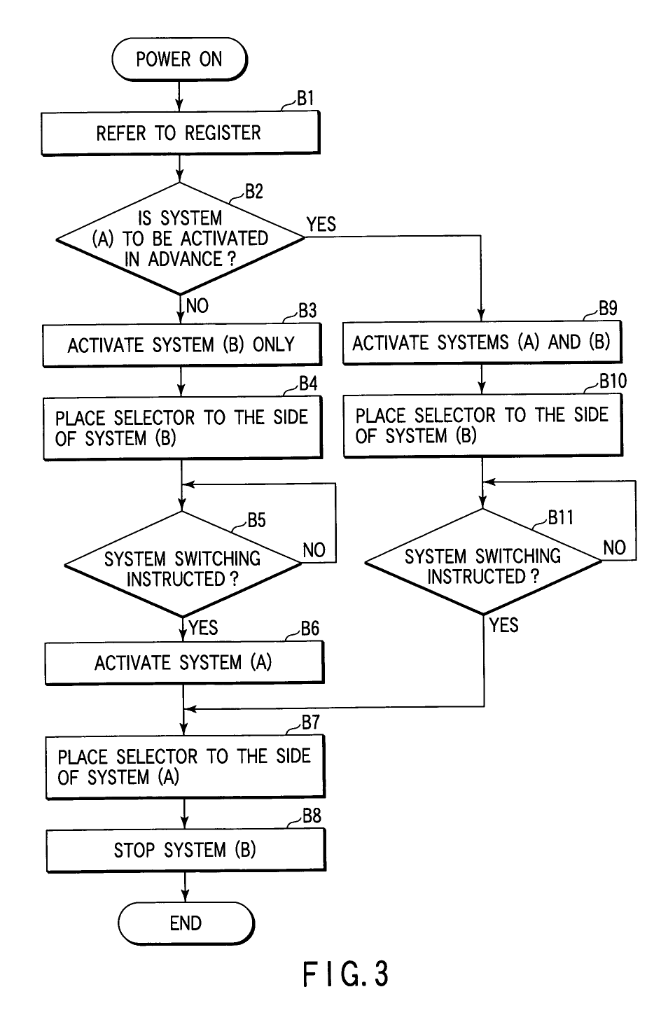

FIG. 3 is a flowchart illustrating the power application control and system switching control in the electronic apparatus of the second embodiment.

When the power button 110 is pressed, the EC 109 first refers to the register 1091 (step B1) and then examines whether or not the power is to be applied in advance to the system (A) 100 as well as the system (B) 200 (step B2). If the contents of the register 1091 are not set so as to apply the power to the system (A) 100 in advance (NO in step B2), then the EC 109 performs the same operations as in the first embodiment (step B3 though step B8).

If, on the other hand, the contents of the register 1091 are set so as to apply the power to the system (A) 100 in advance (YES in step B2), then the EC 109 instructs the EC 207 to apply the power to the system (B) 200 and at the same time starts application of the power to the system (A) 100 (step B9). Thus, the operating system that is multifunctional but long in starting time is also activated on the system (A) 100 at the same time the operating system that is function limited but short in starting time is activated on the system (B) 200. At this point, the EC 109 switches the selectors 301 and 303 to the side of the system (B) 200 (step B10).

The EC 207, after having activated the operating system, monitors whether an instruction to switch between the systems has been given (step B11). If the switching instruction has been given (YES in step B11), the EC 207 notifies the EC 109 to that effect. At this point, since the operating system has already been activated in the system (A) 100, the EC 109 immediately swithes the selectors 301 and 303 to the side of the system (A) 100 (step B7) and instructs the EC 207 to stop the application of the power to the system (B) 200 (step B8). In response to this, the EC 207 presents a shutdown signal to the operating system.

Thus, the electronic apparatus of the second embodiment, having a function of setting whether to apply the power to the system (A) 100 in advance when the power button 110 is pressed, allows the time required to switch to the multifunctional operating system to be reduced for users who use the apparatus much indoors and hence have not to worry about the remaining capacity of the battery 1081.

[Third Embodiment]

A third embodiment of the present invention will be described next.

In the electronic apparatus of the third embodiment, the EC 109 controls the application of the power to the system (A) 100 and the system (B) 200 depending on whether or not the AC adapter is connected to the apparatus. Specifically, if, when the power button 110 is pressed, the AC adapter is connected to the apparatus, then the power is applied in advance to the system (A) 100 as well.

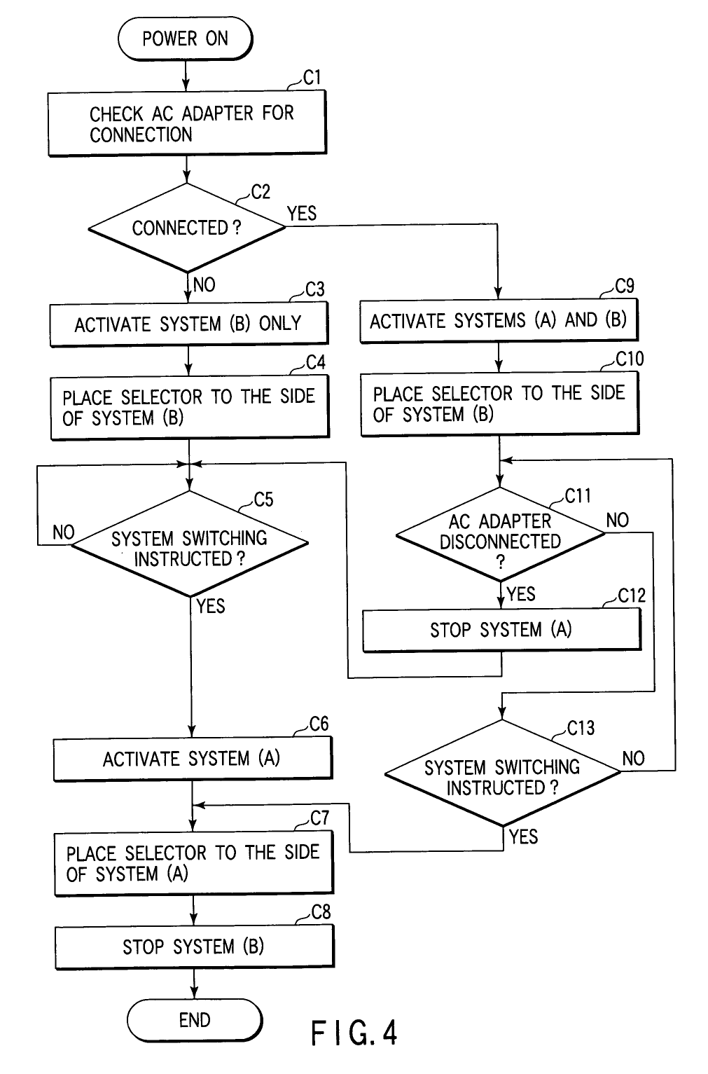

FIG. 4 is a flowchart illustrating the power application control and system switching control in the electronic apparatus of the third embodiment.

When the power button 110 is pressed, the EC 109 first inquires of the PSC 108 as to whether or not the AC adapter is connected to the apparatus (step C1). If the AC adapted is not connected (NO in step C2), then the EC 109 performs the same operations as in the first embodiment (step C3 through step C8).

If, on the other hand, the AC adapter is connected (YES in step C2), then the EC 109 instructs the EC 207 to apply the power to the system (B) 200 and starts itself applying the power to the system (A) 100 (step C9). Thus, not only the operating system that is function limited but short in starting time is started in the system (B) 200, but also the operating system that is multifunctional but long in starting time is started in the system (A) 100. At this point, the EC 109 switches the selectors 301 and 302 to the side of the system (B) 200.

After that, the EC 109 monitors whether or not the AC adapter has been disconnected (step C11). On the other hand, the EC 207 monitors whether or not a system switching instruction has been given (step C13). If the AC adapter has been disconnected (YES in step C11), then the EC 109 stops the application of the power to the system (A) 100 (step C12) and then goes to the process in step CS.

If, on the other hand, the switching instruction has been given (YES in step C13), then the EC 207 notifies the EC 109 to that effect. At this point, since the operating system has already been activated in the system (A) 100, the EC 109 immediately switches the selectors 301 and 303 to the side of the system (A) 100 (step C7). Since it is assumed here that the system (A) 100 and the system (B) 200 are selectively used, the EC 109 recognizes through the switching instruction that the system (B) 200 has become unused and then instructs the EC 207 to stop the application of the power to the system (B) 200 (step C8).

In response to this, the EC 207 presents a shutdown signal to the operating system.

Thus, the electronic apparatus of the third embodiment allows the application of the power to the system (A) 100 and the system (B) 200 to be controlled properly depending on whether the AC adapter is connected or not with no need of user's presetting work.

[Fourth Embodiment]

A fourth embodiment of the present invention will be described next.

The electronic apparatus of the fourth embodiment is configured such that the EC 109 has a function of setting which of the operating system in the system (A) 100 and the operating system in the system (B) 200 to activate when the power button 110 is pressed. The content of this setting is stored in its built-in register 1091, which is updated, for example, by executing a dedicated utility program.

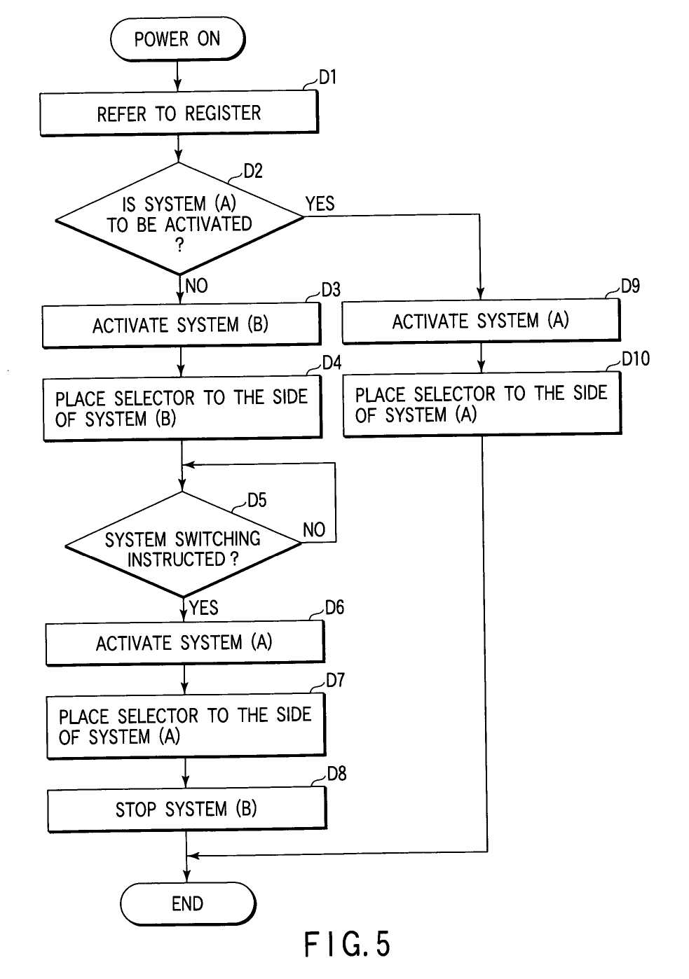

FIG. 5 is a flowchart illustrating the power application control and system switching control in the electronic apparatus of the fourth embodiment.

When the power button 110 is pressed, the EC 109 first refers to the register 1091 (step D1) and then examines whether or not the register content indicates the system (A) 100 is to be started (step D2). If the content of the register 1091 is not set so as to start the system (A) 100 (NO in step D2), then the EC 109 performs the same operations as in the first embodiment (step D3 though step D8).

If, on the other hand, the contents of the register 1091 are set so as to start the system (A) 100 (YES in step D2), then the EC 109 starts the application of the power to the system (A) 100 without instructing the EC 207 to apply the power to the system (B) 200 (step D9). At this point, the EC 109 switches the selectors 301 and 303 to the side of the system (A) 100 (step D10).

Thus, having a function of determining which of the operating system in the system (A) 100 and the operating system in the system (B) 200 to activate when the power button 110 is pressed, the electronic apparatus of the fourth embodiment allows users who use the apparatus much indoors and hence have not to worry about the remaining capacity of the battery 1081 to have the option of activating the multifunctional operating system from the beginning. This results in increased convenience for users.

[Fifth Embodiment]

A fifth embodiment of the present invention will be described next.

The electronic apparatus of the fifth embodiment is configured such that the EC 109 has a function of controlling which of the operating system in the system (A) 100 and the operating system in the system (B) 200 to activate depending on how the power button 110 is pressed. Specifically, when the power button 110 is pressed for more than a given length of time, the operating system in the system (A) 100 is activated; otherwise, the operating system in the system (B) 200 is activated.

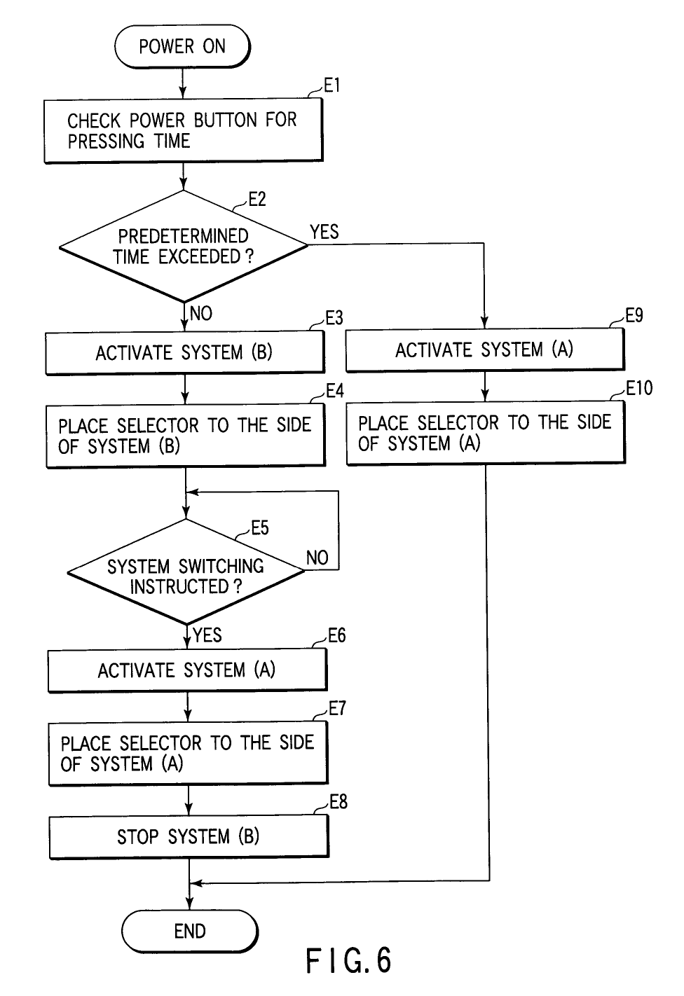

FIG. 6 is a flowchart illustrating the power application control and system switching control in the electronic apparatus of the fifth embodiment.

When the power button 110 is pressed, the EC 109 first monitors the power button 110 for the time during which it is pressed (step E1) and then examines whether or not the time has exceeded a given time (step E2). If the time has not exceeded the given time (NO in step E2), then the embedded controller (EC) 109 performs the same operations as in the first embodiment (step E3 though step E8).

If, on the other hand, the given time has been exceeded (YES in step E2), then the EC 109 starts the application of the power to the system (A) 100 without instructing the EC 207 to apply the power to the system (B) 200 (step E9) and then switches the selectors 301 and 303 to the side of the system (A) 100 (step E10).

It is desirable that the user be allowed to choose the system which is started when the power button 110 is pressed for less than a predetermined time from the system (A) 100 and the system (B) 200 at his discretion. To this end, the user simply sets the content of his choice in the register 1091 and updates it using a dedicated utility program.

Thus, the electronic apparatus of the fifth embodiment allows the activation of the system (A) 100 and the system (B) 200 to be controlled properly depending on how the power button 110 is pressed with no need of user's presetting work.

[Sixth Embodiment]

A sixth embodiment of the present invention will be described next.

The electronic apparatus of the sixth embodiment is configured such that the EC 109 has a function of, when the power button 110 is pressed, automatically and selectively activating the system which had been used immediately before the last system shutdown. To this end, the EC 109 stores information indicating the system which had been used immediately before the last system shutdown into the register 1091.

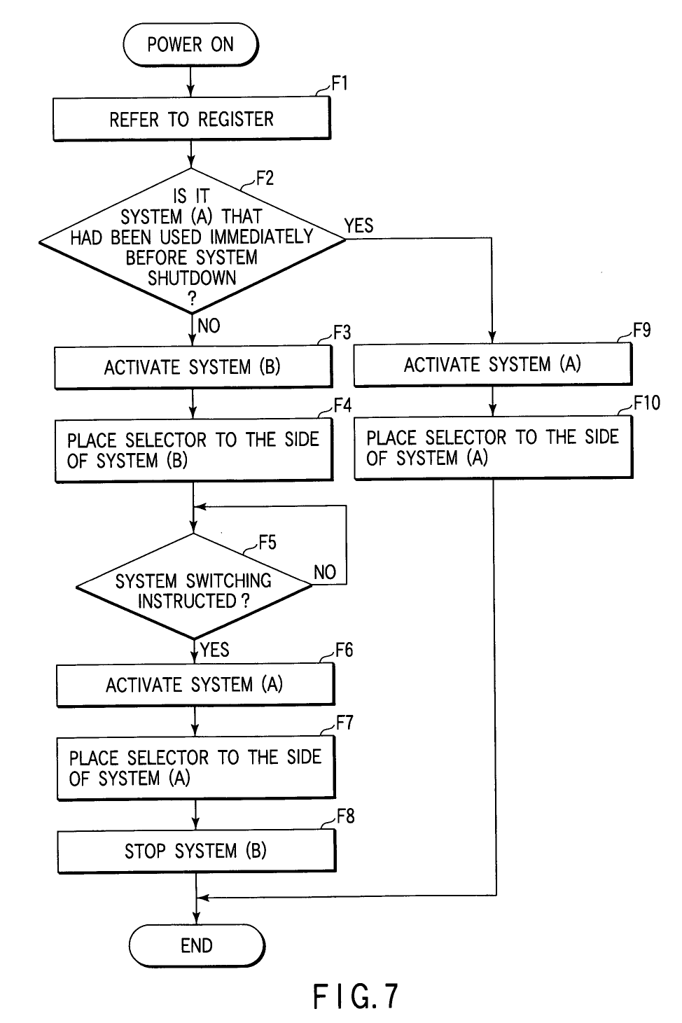

FIG. 7 is a flowchart illustrating the power application control and system switching control in the electronic apparatus of the sixth embodiment.

When the power button 110 is pressed, the EC 109 first refers to the register 1091 (step F1) and then examines whether or not it is the system (A) 100 that had been used immediately before the last system shutdown (step F2). If the system (A) 100 had not been used (NO in step F2), then the EC 109 performs the same operations as in the first embodiment (step F3 though step F8).

If, on the other hand, the system (A) 100 had been used (YES in step F2), then the EC 109 starts the application of the power to the system (A) 100 without instructing the EC 207 to apply the power to the system (B) 200 (step F9) and then switches the selectors 301 and 303 to the side of the system (A) 100 (step F10).

Thus, the electronic apparatus of the sixth embodiment allows the system that had been used immediately before the last system shutdown to be activated, that is, the system most likely to be used to be chosen automatically, when the power button 110 is pressed. This results in increased convenience for users.

[Seventh Embodiment]

A seventh embodiment of the present invention will be described next.

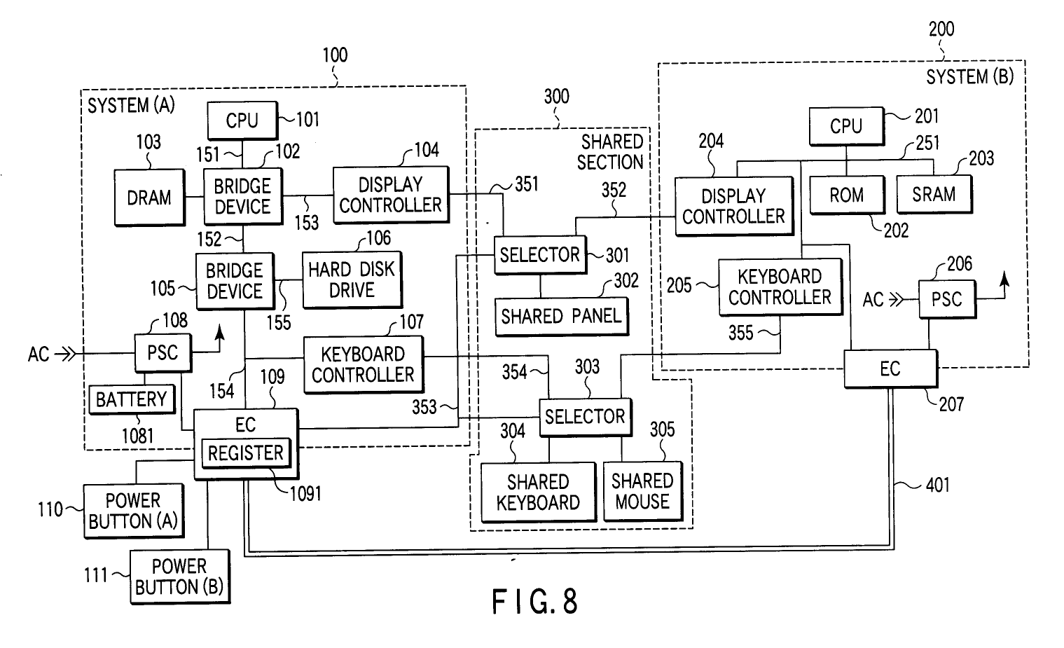

FIG. 8 is a block diagram of a piece of electronic apparatus according to the seventh embodiment of the present invention. As shown, the electronic apparatus of this embodiment includes a power button 111 in addition to the power button 110. The EC 109 activates the system (A) 100 when the power button 110 is pressed and the system (B) 200 when the power button 111 is pressed. To facilitate understanding of the explanation, the power buttons 110 and 111 are referred hereinafter to as the power button (A) 110 and the power button (B) 111, respectively.

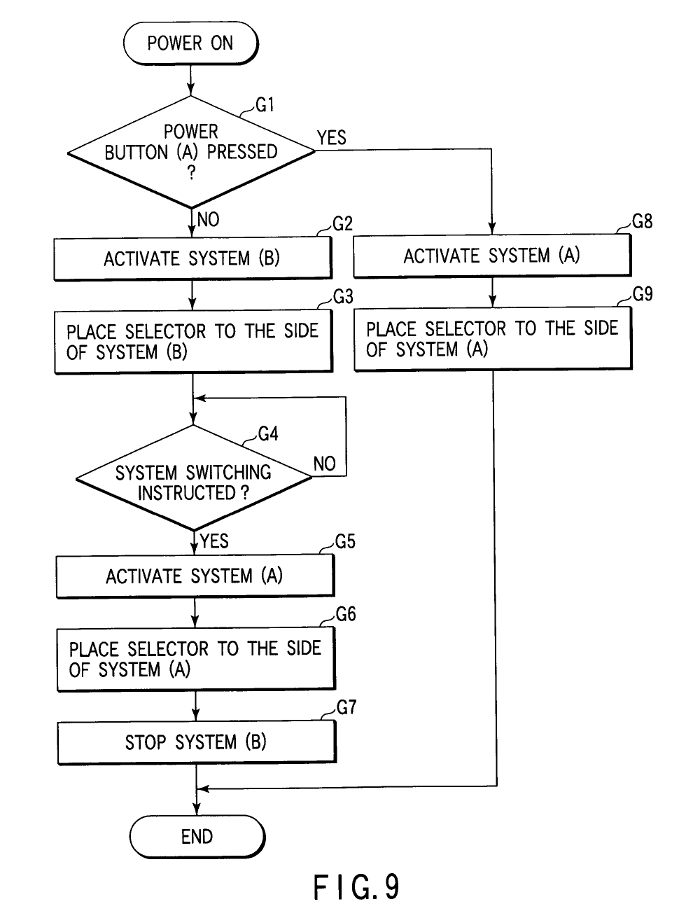

FIG. 9 is a flowchart illustrating the power application control and system switching control in the electronic apparatus of the seventh embodiment.

When a power button is pressed, the EC 109 first examines whether or not that power button is the power button (A) 110 (step G1). If the pressed power button is not the power button (A) 110 (NO in step G1), then the EC 109 performs the same operations as in the first embodiment (step G2 though step G7).

If, on the other hand, the pressed power button is the power button (A) 110 (YES in step G1), then the EC 109 starts the application of the power to the system (A) 100 without instructing the EC 207 to apply the power to the system (B) 200 (step G8) and then switches the selectors 301 and 303 to the side of the system (A) 100 (step G9).

Thus, the electronic apparatus of the seventh embodiment allows the user to easily choose the system to be activated through the selective use of the power buttons.

[Eighth Embodiment]

An eighth embodiment of the present invention will be described next.

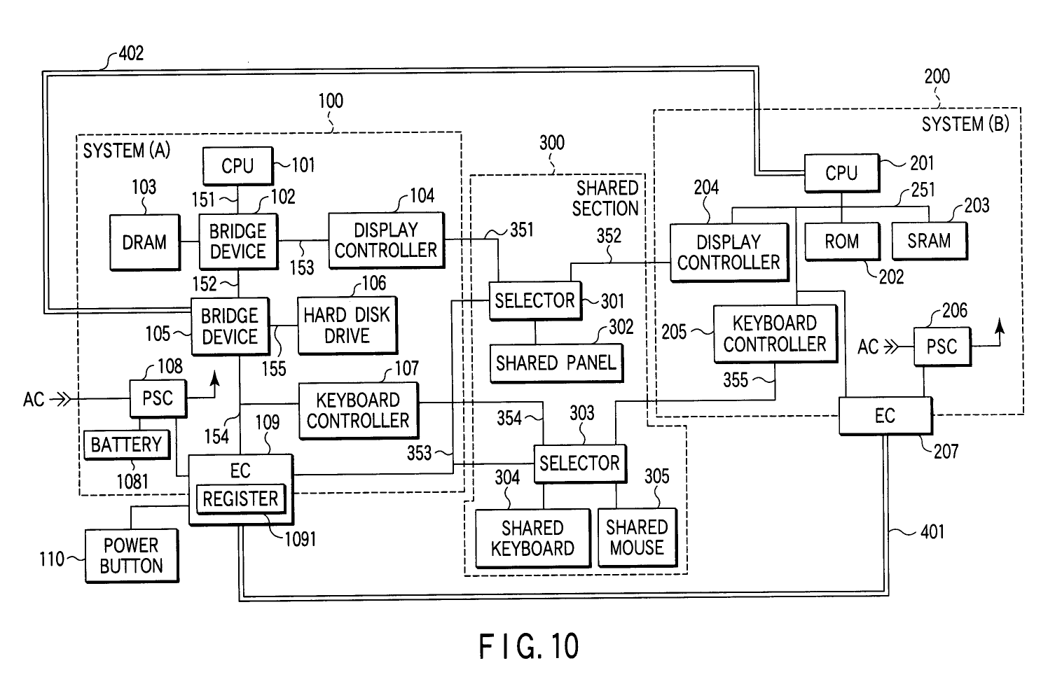

FIG. 10 is a block diagram of a piece of electronic apparatus according to the eighth embodiment of the present invention. As shown, the electronic apparatus of this embodiment is equipped with a bus 402 that allows the operating system in the system (A) 100 and the operating system in the system (B) 200 to share a file. It is assumed here that a schedule management file is contained in the SRAM 203 in the system (B) 200 and available not only to the operating system in the system (B) 200 but also to the operating system in the system (A) 100.

Suppose now that the operating system in the system (A) 100 is used, while the operating system in the system (B) 200 is in the stopped state. Upon the occurrence of a process to update the schedule management file, the operating system in the system (A) 100 notifies the EC 109 to that effect. The EC 109 then presents this notification to the EC 207.

The EC 207 starts the application of the power to the system (B) 200 to activate its operating system. At this point, the EC 207 applies the power to only portions involved in updating the schedule management file contained in the SRAM 203. Namely, the power is not applied to the display controller 204 and the keyboard controller 205 by way of example, thus avoiding waste of power. When the operating system is activated, the EC 207 notifies the EC 109 to that effect. The EC 109 presents this notification to the operating system in the system (A) 100.

Upon receipt of the notification, the operating system in the system (A) 100 updates the schedule management file contained in the SRAM 203 while communicating with the operating system in the system (B) 200 via the bus 402. At the termination of updating, the operating system in the system (A) 100 instructs the operating system in the system (B) 200 to shut down via the bus 402.

Thus, the electronic apparatus of the eighth embodiment in which provision is made for allowing the system (A) 100 and the system (B) 200 to share, for example, a schedule management file contained in the SRAM 203 allows either system to refer to the same schedule.

Although the embodiment has been described in terms of an application in which a schedule management file is shared between the two operating systems, this is not restrictive. For example, an environment setup file for setting up an operating environment may be shared between the two operating systems. In this case, the operating environment set up by one operating system is also applied to the other operating system, allowing either system to offer the same sense of use to the user.

Although the embodiment has been described in terms of an application in which the same file is shared between the two operating systems, this is not restrictive. For example, the intended object can be achieved by allowing the two operating systems to have similar files and coordinating, i.e., synchronizing the contents of these files at a predetermined time. Specifically, if, when one operating system is activated or stopped, it synchronizes given files while communicating with the other operating system via the bus 402, it becomes possible for either system to refer to the same schedule.

[Ninth Embodiment]

A ninth embodiment of the present invention will be described next.

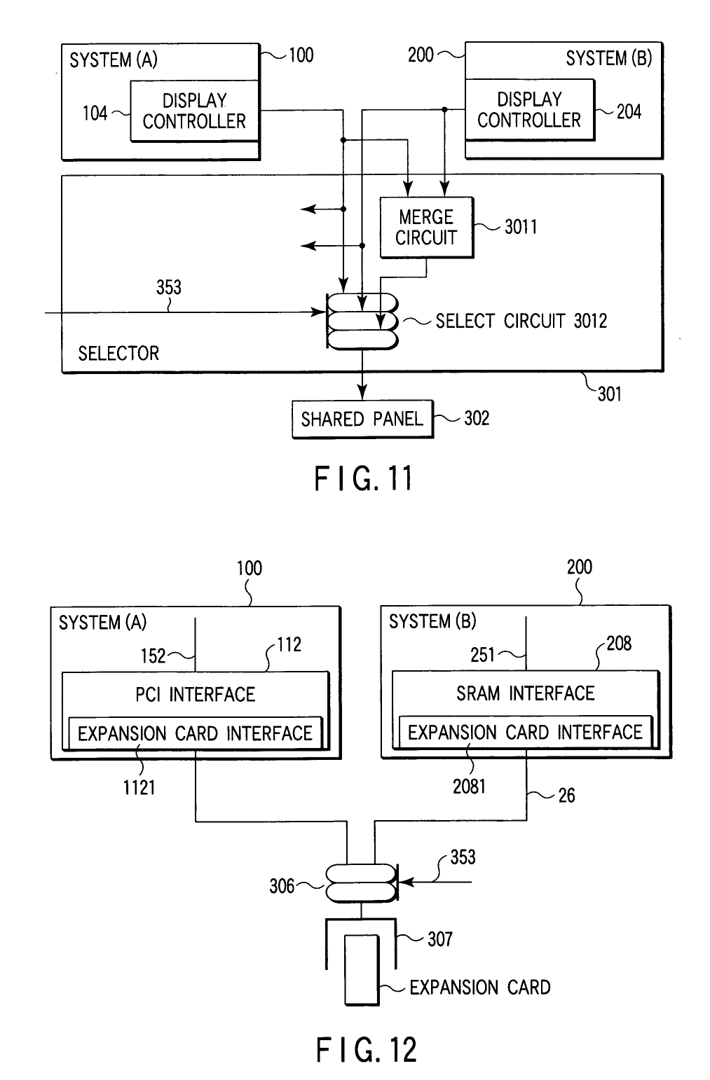

FIG. 11 is a block diagram of a piece of electronic apparatus according to the ninth embodiment of the present invention. As shown, the electronic apparatus of this embodiment allows display data output from the display controllers 104 and 204 of the system (A) 100 and the system (B) 200 to be displayed superimposed upon each other on the shared panel 302 (as opposed to the shared panel being exclusively employed by each of the systems). To this end, in the electronic apparatus of the ninth embodiment, the selector 301 has a merge circuit 3011.

The merge circuit 3011 is a so-called raster operation circuit that receives display data output from the display controller 104 in the system (A) 100 and display data output from the display controller 204 in the system (B) 200, then synchronizes both the display data in display time and superimposes the display data upon each other.

When only the operating system in the system (A) 100 is operated, the EC 109 outputs a signal to select the display data output from the display controller 104 onto the select signal line 353. When only the operating system in the system (B) 200 is operated, a signal to select the display data output from the display controller 204 is output onto the select signal line 353. When the operating system in the system (A) 100 and the operating system in the system (B) 200 are both operated, the EC 109 outputs onto the select signal line 353 a signal to select display data subjected to display timing synchronization and superimposition processing in the merge circuit 3011.

Each select signal output onto the select signal line 353 is applied to a select circuit 3012. In response to this select signal, the select circuit 3012 selects a corresponding one of the display data output from the display controller 104 in the system (A) 100, the display data output from the display controller 204 in the system (B) 200, and the display data output from the merge circuit 3011 and then outputs the selected display data to the shared panel 302.

Thus, the electronic apparatus of the ninth embodiment, owing to the provision of the merge circuit 3011 in the selector 301, allows display data output from the system (A) 100 and the system (B) 200 to be displayed superimposed upon each other on the shared panel 302 without imposing any burden on each of these systems.

[Tenth Embodiment]

A tenth embodiment of the present invention will be described next.

The electronic apparatus of this embodiment is configured such that the shared unit 300 is equipped with a card slot into which an expansion card (PC card) can be plugged to increase the functions or performance of the apparatus itself. FIG. 12 shows the arrangement associated with the card slot in the shared unit 300 of the electronic apparatus of the tenth embodiment.

As shown in FIG. 12, in the electronic apparatus of the tenth embodiment, the shared section 300 is provided with a card slot 307 into which an expansion card can be plugged and a selector 306 which gives the exclusive right of using the card slot 307 to either of the system (A) 100 and the system (B) 200.

The system (A) 100 is provided with a PCI interface 112 that connects the expansion card to the PCI bus 152. The system (B) 200 is provided with an SRAM interface 208 that connects the expansion card to the SRAM bus 251. The PCI interface 112 and the SRAM interface 208 have PC card interfaces 1121 and 2081, respectively, which allow data to be transmitted to or received from the expansion card.

The selector 306 also responds to a signal output onto the select signal line 353 from the EC 109 to switch between the system (A) 100 and the system (B) 200. In the electronic apparatus of the tenth embodiment equipped with the card slot 307, the EC 109 and the EC 207 carry out system switching in accordance with the following procedure:

First, the operating system in the system which has been selected so far is stopped. After that, the operating system in the system which is to be selected hereafter is activated. Thus, the expansion card plugged into the card slot 307 is allocated to the operating system selected anew.

To switch between the systems with their operating systems kept operating, the EC 109 and the EC 207 notify the operating system in the system which has been selected so far to the effect that the expansion card was unplugged from the card slot 307 (though in fact it is not unplugged). Based on this notification, the card eject processing is carried out. After that, the operating system in the system which is to be selected hereafter is notified to the effect that the expansion card was plugged into the card slot 307 (though in fact it remains plugged into the slot) and then caused to carry out card detection processing.

Thus, the electronic apparatus of the tenth embodiment allows switching between the systems while continuing the use of the expansion card plugged into the card slot 307.

Although the embodiments have been described in terms of an application in which an operating system that is multifunctional but long in starting time and an operating system that is function limited but short in starting time are combined, this is not restrictive. For example, the principles of the invention are also applicable to the case where two operating systems of the same level but different kinds are combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. Electronic apparatus comprising:
a first system having a first CPU;
a second system having a second CPU;
a connection unit configured to connect the first system and the second system; and
a power application control unit configured to control the application of power to the first system and the second system through the connection unit.

2. The electronic apparatus according to claim 1, wherein the power application control unit include a setting unit configured to selectively set a first power application mode in which the application of power to only the first system is started and a second power application mode in which the application of power to both the first system and the second system is started, upon receipt of a power application instruction.

3. The electronic apparatus according to claim 1, wherein the power application control unit include a decision unit configured to decide whether or not the power is applied from an external power supply; and a power supply starting unit configured to start the application of power to only the first system when the decision is that the power is not applied from an external power supply and start the application of power to both the first system and the second system when the decision is that the power is applied from an external power supply, upon receipt of a power application instruction.

4. The electronic apparatus according to claim 3, wherein the power application control unit include a power supply stopping unit configured to stop the application of the power to one of the first system and the second system which is not in use, upon detecting that the application of power from an external power supply is interrupted.

5. The electronic apparatus according to claim 1, wherein the power application control unit include a power supply starting unit configured to start the application of power to one of the first system and the second system, responsive to an instruction from the other.

6. The electronic apparatus according to claim 5, wherein the power application control unit include a power supply stopping unit configured to stop the application of power to the other of the first system and the second system, after the application of power to one of the first system and the second system is started in response to an instruction from the other.

7. The electronic apparatus according to claim 1, further comprising a peripheral device shared by the first system and the second system and a selector which selectively connects the peripheral device to the first system and the second system, wherein the power application control unit include a selector controlling unit configured to control the selector according to usage of the first system and the second system.

8. The electronic apparatus according to claim 7, wherein the selector controlling unit of the power application control unit causes the system which has been connected to the card slot to execute processing to be performed when the expansion card is removed and, after this execution, causes the system to which the card slot is connected to execute processing to be performed when the expansion card is plugged into the card slot, when the connection of the card slot is switched from one of the first system and the second system to the other in a state where both the first system and the second system are activated.

9. The electronic apparatus according to claim 1, further comprising a display device shared by the first system and the second system; and a combining unit configured to combine image data output from the first system and the second system to the display device.

10. Electronic apparatus comprising:
a first system having a first CPU;
a second system having a second CPU;
a connection unit configured to connect the first system and the second system; and
a system switching unit configured to switch between the first system and the second system for selective use thereof through the connection unit.

11. The electronic apparatus according to claim 10, wherein the system switching unit include a setting unit configured to set the system to be activated, upon receipt of a system activate instruction.

12. The electronic apparatus according to claim 10, further comprising a button to instruct system activation,
wherein the system switching unit activates the first system when the button is pressed for more than a predetermined length of time and activates the second system when the button is pressed for less than the predetermined length of time.

13. The electronic apparatus according to claim 12, wherein the system switching unit include a substituting unit configured to substitute the system to be activated when the button is pressed for more than a predetermined length of time with the system to be activated when the button is pressed for less than the predetermined length of time so that the second system is activated when the button is pressed for more than the predetermined length of time.

14. The electronic apparatus according to claim 10, wherein the system switching unit activates the system which had been used immediately before the last system shutdown, upon receipt of an system activate instruction.

15. The electronic apparatus according to claim 10, further comprising a first button and a second button to instruct system activation,
wherein the system switching unit activate the first system when the first button is pressed and activate the second system when the second button is pressed.

16. The electronic apparatus according to claim 10, wherein the system switching unit switches from the first system to the second system, upon receipt of an instruction to execute a program which can be run on the second system while the first system is in use.

17. Electronic apparatus comprising:
a first system having a first CPU;
a second system having a second CPU;
a connection unit configured to connect the first system and the second system; and
a file management unit configured to manage a file retained by the first system and a file retained by the second system through the connection unit.

18. The electronic apparatus according to claim 17, wherein the file management unit has synchronizing unit configured to synchronize the file retained by the first system and the file retained by the second system at a predetermined time.

19. The electronic apparatus according to claim 17, further comprising a peripheral device shared by the first system and the second system; and a selector which selectively connects the peripheral device to the first system and the second system,
wherein the file management unit controls the selector according to use of the first system and the second system.
